(19) United States
(12) Patent Application Publication
(10) Pub. No.: US 2020/0324155 A1
(43) Pub. Date: Oct. 15, 2020

(54) Vacuum Dry Fire Protection Sprinklers, Systems and Methods

(71) Applicant: Minimax Viking Research & Development GmbH, Bad Oldesloe (DE)

(72) Inventor: Scott T. Franson, Hastings, MI (US)

(21) Appl. No.: 16/844,139

(22) Filed: Apr. 9, 2020

Related U.S. Application Data
(60) Provisional application No. 62/831,501, filed on Apr. 9, 2019.

(51) Int. Cl. A62C 35/62; A62C 37/11

(52) U.S. Cl. CPC A62C 35/62; A62C 35/68; A62C 37/11

(57) ABSTRACT

Automatic fire protection sprinklers, systems and methods for vacuum dry sprinkler protection. The sprinklers include a seal assembly having a translator configured to overcome or break a vacuum force and pivot out of the fluid flow path of the sprinkler.

### PRIORITY CLAIM & INCORPORATION BY REFERENCE

This application claims the benefit of U.S. Provisional Application No. 62/831,501 filed Apr. 9, 2019, which is incorporated by reference in its entirety.

### TECHNICAL FIELD

The invention relates generally to automatic fire protection sprinklers and in particular, automatic fire protection sprinklers for use in vacuum dry sprinkler systems.

### BACKGROUND ART

A wet pipe or wet fire protection sprinkler system is one in which the system fluid supply piping is filled with pressurized firefighting fluid such as, for example, water in the system ready, non-actuated state. In contrast, a dry pipe or dry fire protection sprinkler system is one in which the fluid supply piping is filled with a pressurized gas such as, for example, air or nitrogen, in the system ready non-actuated state. Dry fire protection sprinkler systems are known in the industry and utilized in applications wherein it is disadvantageous to have water or other firefighting fluid residing within the fluid supply pipes of the system when the sprinkler system is in a ready non-actuated state. One specific application in which dry sprinkler systems are used include warehouses and other commercial environments wherein the temperature is low enough to cause freezing of the fluid within the pipes.

One type of dry sprinkler system is a vacuum dry sprinkler system. In a vacuum dry sprinkler system, automatic fire protection sprinklers are coupled to a network of fluid supply pipes. Generally, automatic fire protection sprinklers include a frame having a solid metal body and some type of deflector to distribute fluid discharged from the body in a defined spray distribution pattern over an area to address a fire. The body includes a fluid inlet, a discharge outlet or orifice with an internal passageway extending between the inlet and the outlet. The fluid deflector is axially spaced from the discharge orifice to define a fluid flow path in between. Automatic sprinklers can be characterized by their discharge characteristics. The discharge or flow characteristics from the sprinkler body is defined by the internal geometry of the sprinkler including its internal passageway, inlet and outlet (the orifice) and quantified by the industry accepted discharge coefficient or nominal K-factor. As is known in the art, the K-factor of a sprinkler is defined as K=Q/P^{1/2}, where Q represents the flow rate (in gallons/min GPM) of water from the outlet of the internal passage through the sprinkler body and P represents the pressure (in pounds per square inch (psi.)) of water or firefighting fluid fed into the inlet end of the internal passageway though the sprinkler body.

Fluid discharge from an automatic fire protection sprinkler is automatically controlled by operation of a thermally responsive actuator or trigger that maintains a fluid tight seal at the discharge orifice by means such as the exertion of pressure on a sealing assembly. There are generally two types of thermally responsive triggers: frangible and non-frangible. Frangible actuators generally include a liquid-filled frangible bulb that shatters upon reaching its rated temperature. Non-frangible actuators can include fusible links or soldered mechanical arrangements in which the components of the assembly separate upon fusion of the solder reaching its rated temperature. When the temperature surrounding the sprinkler is elevated to a pre-selected value indicative of a fire, the trigger operates thereby permitting ejection and release of the sealing assembly. In the case of wet fire protection sprinkler systems, fluid pressure is applied to the released sealing assembly to facilitate the ejection of the sealing assembly and the fluid discharge. Sealing assemblies generally include a sealing cap, button or disc disposed in the outlet; and some sealing assemblies can include a lever structure that forms a pivoted relationship with the sprinkler frame to facilitate ejection of the sealing assembly out of the fluid discharge path. Examples of sealing assemblies in a pivoted relationship with a sprinkler frame are shown in the following patent documents: U.S. Patent Publication No. 2017/0312561; U.S. Pat. No. 4,108,247; European Patent Application Publication EP 1690635; German Patent Publication No. DE 20202015, and PCT International Patent Application Publication No. 2019/0236973.

In an unactuated state of the vacuum dry fire protection system, the fluid supply pipes are subjected to a vacuum which imparts a negative pressure, normally below atmospheric pressure, upon each sprinkler in the system. The vacuum pressure subjects the sealing assembly in each sprinkler to a vacuum force which pulls the sealing assembly into the outlet. In a proper response to a fire, one or more of the sprinklers of a vacuum dry sprinkler system thermally actuates by operation or rupture of its thermally sensitive trigger members and the sealing assembly is expelled from the outlet which opens each thermally actuated sprinkler. Positive pressure at or above atmospheric pressure flows into the open sprinklers and flows into the supply pipes. The positive pressure experienced by the system activates a control assembly coupled to the pipes which subsequently releases water or other firefighting fluid under pressure through the supply lines. This firefighting fluid is delivered to each of the sprinklers and is expelled from the open sprinklers to address the fire. An example of a vacuum dry fire sprinkler system is disclosed in U.S. Pat. No. 5,927,406, issued to Kadoche on Jul. 27, 1999.

One problem in vacuum dry sprinkler systems is overcoming or breaking the vacuum pressure to open the sprinkler after the thermally responsive trigger operates or ruptures. Sometimes the applied negative pressure and vacuum force within the system pipes can inhibit or prevent the proper or complete removal of the sealing assembly from the orifice outlet of the thermally actuated sprinkler. Another problem can occur even if the sealing assembly successfully overcomes or breaks the vacuum pressure. Sometimes the expelled sealing assembly bounces off the deflector or the sprinkler frame and is deflected back towards the orifice outlet. If there is still a vacuum or negative pressure within the sprinkler passageway, the sealing assembly can be drawn back into the orifice outlet, thereby blocking or resealing the orifice outlet. This resealing prohibits the activation of the vacuum dry sprinkler system. When the sealing assembly remains in or blocks the orifice outlet and/or flow path of a thermally actuated sprinkler, positive pressure cannot enter the supply pipes and the vacuum pressure of the system is maintained thereby preventing proper actuation of the vacuum dry sprinkler system in response to a fire.

U.S. Pat. No. 6,715,561 shows and describes a solution to overcome these problems in vacuum dry fire protection systems. U.S. Pat. No. 6,715,561 shows and describes an expulsion assembly that includes an expulsion member in the form of a Belleville spring and a thrust member in the form of a wire spring. The expulsion member is configured to sequentially overcome the vacuum pressure and the thrust member acts on the sealing assembly to thrust in a lateral direction out of the sprinkler flow path.

A known commercial sprinkler for use in vacuum dry systems is a large orifice sprinkler, e.g., having a nominal K-factor of over K 14.0 GPM/(PSI)^{1/2} (K14) and more particularly a nominal K-factor of K 25.2 GPM/(PSI)^{1/2} (K25). The commercially available sprinkler is the VK598 (K25.2) from The Viking Corporation of Hastings, Mich., USA which is shown and described in published Technical Data Sheet, Form No. F_090414, “Standard Response Upright Sprinkler VK598 (K25.2)” Rev. 17.1 (Nov. 1, 2018). The commercial sprinkler includes a sealing cap and an expulsion member embodied as an annular spring externally affixed about the sealing cap. The external spring overcomes the vacuum force and the sealing cap forms a pivot contact engagement with the sprinkler frame to pivot the sealing cap out of the fluid flow path.

There remains a need for vacuum dry sprinkler systems and methods that use automatic sprinklers with sealing arrangements that avoid or eliminate the above described operational problems. Moreover, it is desirable to have automatic fire protection sprinklers with discharge coefficients of less than K25 and even more preferably with small discharge coefficients, e.g., nominal K-factor of K 11.0 GPM/(PSI)^{1/2} or less.

### DISCLOSURE OF INVENTION

Preferred embodiments of vacuum dry sprinklers, systems and methods of fire protection that are described herein include a preferred sealing assembly having a translator to overcome or break the force of the vacuum or negative pressure on the seal assembly upon thermal actuation of the sprinkler. Preferred embodiments of the translator provide for a moment generator that facilitates proper and complete ejection of the sealing assembly. Preferred embodiments of the translator form a pivoted engagement with the sprinkler frame to overcome the vacuum force and rotate the sealing assembly out of the fluid flow path of the sprinkler. Moreover, preferred embodiments of the translator are combined with a sprinkler frames having an orifice with a discharge coefficient of a preferred nominal K-factor of less than K 25.2 GPM/(PSI)^{1/2} to provide for vacuum dry fire protection sprinklers that eliminates the need for an expulsion member and/or thrust member.

Preferred embodiments of the translator include a first shell cap portion and second lever member portion affixed to the shell cap. The second lever portion forms the preferred pivoted relationship with the sprinkler frame. A preferred shell cap portion provides a receptacle and preferred embodiments of the seal assembly include a seating disc disposed within the receptacle for seating a thermally responsive trigger. Upon thermal actuation of the trigger, the seating disc is displaced within the receptacle and impacts the shell cap portion to impart a momentum to the translator to translate the sealing assembly out of the fluid flow path of the sprinkler.

One preferred embodiment of a vacuum dry sprinkler system includes a fire extinguishing fluid supply line and a control system operably connected to the fire extinguishing fluid supply line. The control system is preferably configured to maintain the fire extinguishing fluid supply line at below atmospheric or negative pressure during a non-activated condition and supply a fire extinguishing fluid to the fire extinguishing fluid supply line upon exposure to pressure equal to or greater than atmospheric pressure in response to a fire. In the preferred system, a plurality of vacuum dry sprinklers is coupled to the fire extinguishing fluid supply line. A preferred vacuum dry sprinkler includes a frame including a frame having body having an inlet, an outlet and an internal passageway extending between the inlet and the outlet along a longitudinal sprinkler axis. The sprinkler body has a preferred nominal K-factor of less than 25.2 GPM/(PSI)^{1/2}. A fluid deflecting member is spaced from the outlet at a fixed axial distance from the outlet to define a fluid flow path in between and a thermally sensitive trigger disposed between the fluid deflecting member and the outlet along the sprinkler axis. A preferred seal assembly is engaged with the trigger to form a fluid tight seal within the outlet. The seal assembly includes a preferred translator in a pivoted relationship with the frame upon rupture of the thermally responsive trigger to pivot the sealing assembly out of the fluid flow path.

A preferred method of vacuum dry sprinkler protection includes configuring a plurality of fire extinguishing fluid supply lines to be below atmospheric or negative pressure during a non-activated condition and forward a fire extinguishing fluid to the plurality of fire extinguishing fluid supply lines upon exposure to pressure equal to or greater than atmospheric pressure in an activated condition. The preferred method also includes coupling a plurality of vacuum dry sprinklers to the plurality of fire extinguishing fluid supply lines in which each of the vacuum dry sprinklers preferably includes a frame including a frame having body having an inlet, an outlet and an internal passageway extending between the inlet and the outlet along a longitudinal sprinkler axis, the sprinkler body has a nominal K-factor of less than 25 GPM/(PSI)½. Each of the preferred sprinklers include a fluid deflecting member spaced from the outlet at a fixed axial distance from the outlet to define a fluid flow path in between; a thermally sensitive trigger disposed between the fluid deflecting member and the outlet along the sprinkler axis; and a seal assembly engaged with the trigger to form a fluid tight seal within the outlet. The seal assembly including a preferred translator in a pivoted relationship with the frame upon operation of the thermally responsive trigger to pivot the seal assembly out of the fluid flow path.

Another preferred method of vacuum dry fire protection includes obtaining an automatic fire protection sprinkler having a nominal K-factor of 11.2 GPM/(PSI)^{1/2} or less; and providing the fire protection sprinkler suitable for installation in a vacuum dry fire protection system having a supervisory vacuum pressure. Sprinklers of the preferred systems and methods include a preferred moment generator that imparts a moment to the translator upon operation of the thermally responsive trigger. A preferred embodiment of the moment generator includes a shell cap defining a receptacle and a seating disc disposed within the receptacle to seat a thermally responsive trigger such that the operation of the thermally responsive trigger causes displacement of the seating disc to impact the shell cap and impart momentum to the translator.

### BRIEF DESCRIPTION OF DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1 is an illustrative schematic of a preferred embodiment of a vacuum dry fire protection sprinkler system.

FIG. 2 is a front view of a preferred automatic fire protection sprinkler for use in the system of FIG. 1.

FIG. 3 is a cross-sectional view of the sprinkler of FIG. 2.

FIG. 4 is another cross-sectional view of the sprinkler of FIG. 2.

FIG. 4A is a detailed cross-sectional schematic view of a preferred sealing assembly being expelled from the sprinkler in FIG. 4.

### MODE(S) FOR CARRYING OUT THE INVENTION

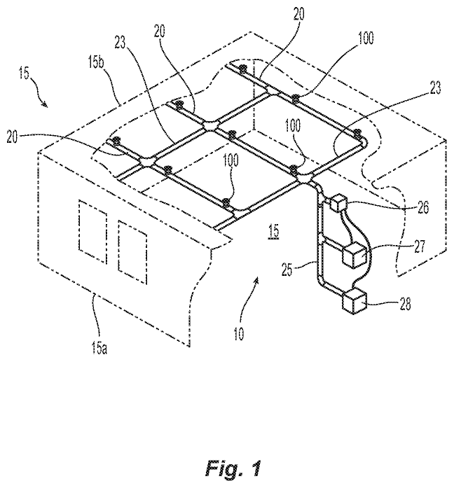

Schematically shown in FIG. 1 is a preferred vacuum dry sprinkler system 10 positioned within an enclosure 15. The vacuum dry sprinkler system 10 generally includes one or more fluid supply lines 20 positioned within the enclosure 15, a preselected distance above floor 15a and below ceiling 15b. Secured to at regular intervals along and in fluid communication with fluid supply lines 20 are preferred automatic vacuum dry fire protection sprinklers 100 for addressing a fire and protecting the enclosure 15. The sprinklers 100 of system 10 are schematically depicted in FIG. 1 as upright-type sprinklers. However, it will be recognized by those with ordinary skill in the art and as described herein, preferred embodiments of the sprinklers 100 and system 10 can be alternatively configured for a pendent-type installation.

In the dry vacuum system 10, supply lines 20 are in fluid communication with a system line 25 which is operably connected to a control system 26. Control system 26 is in turn connected to a pump 27 and a pressurized fire extinguishing fluid supply such as, for example, water source 28. In an unactuated state of the system 10, the control system 26 activates pump 27 to draw a vacuum through the system line 25 and into supply lines 20 and cross supply lines 23. In the non-activated or unactuated state of the system 10, pump 27 exerts a negative pressure or vacuum upon supply lines 20 and sprinklers 100 and their sealing assemblies. In preferred embodiments of the system, the vacuum pressure applied to each sprinkler 100 is preferably no more than −3 psi of supervisory vacuum pressure.

When the temperature within enclosure 15 is elevated to a preselected value indicative of a fire, sprinklers 100 are thermally actuated to initiate operation of the system 10. As described herein, preferred embodiments of the system 10 include sprinklers 100 with a translator to break the applied vacuum pressure and pivot the sealing assembly out of the sprinkler flow path without the need of an expulsion member or thrust member. With the actuated sprinklers 100 opened to atmosphere, the connected supply lines 20 are exposed to atmospheric or a positive pressure above that experienced during the non-activated condition. This positive pressure is then experienced by control system 26 which in turn activates pressurized water source 28, resulting in the forwarding of water throughout supply lines 20 and cross supply lines 23. The water is subsequently discharged from open sprinklers 100 to address the fire or wet the surrounding area.

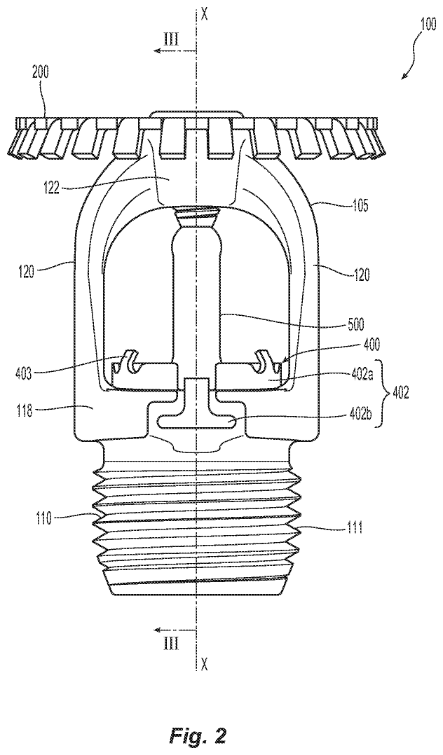

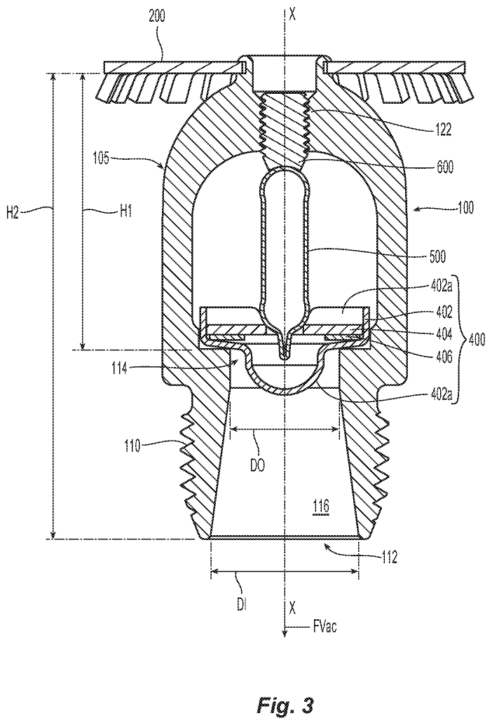

Shown in FIGS. 2 and 3 is a preferred embodiment of fire protection sprinklers 100 for coupling to the supply lines 20 of the vacuum dry sprinkler system 10. The preferred sprinkler 100 has a preferred discharge coefficient less than a nominal K-factor of K 25.2 GPM/(PSI)^{1/2} (hereinafter K25) and more preferably has a small discharge coefficient, e.g., with a nominal K-factor of K 11.2 GPM/(PSI)^{1/2} (hereinafter K11) or less and a preferred seal assembly 400 that includes a translator 402 that translates the seal assembly out of the sprinkler outlet and the fluid flow path of the sprinkler. The frame 105 includes a body 110 having an inlet 112, a discharge outlet 114 and an internal passageway 116 axially aligned with one another along a longitudinal sprinkler axis X-X. The preferred frame 105 includes a pair of frame arms 120 to support and locate a fluid deflection member or deflector 200 at a fixed distance along the longitudinal sprinkler axis from the outlet 114 for distributing a firefighting fluid to address a fire. The pair of frame arms 120 extend from the body 110 at diametrically opposed sides of the outlet 114 and converge toward one another to form and/or support a deflector boss 122 that is centered along the sprinkler axis X-X at a fixed distance from the outlet 114. The deflector 200 can be configured for installation in an upright orientation, for example as shown, in which supplied firefighting fluid is discharged from the outlet 114 to impact the deflector 200 in an upward direction toward the ceiling 15b of the enclosure 15. Alternatively, the affixed deflector 200 can be formed or configured for a pendent orientation, as described herein, in which fluid is discharged from the outlet 114 in a downward direction toward the floor 15a of the enclosure 15 or in a sidewall orientation in which water is discharged horizontally with respect to the floor 15a.

FIG. 3 shows the cross-sectional view of the body 110 and its internal passageway 116. Fluid supplied to the sprinkler inlet 112 flows through the internal passageway 116 and is discharged from the outlet 114 to impact the deflector 200 to address a fire. The inlet 112 defines a first internal diameter DI of the sprinkler body 110 and the outlet 114 defines a second internal diameter DO, which is smaller than the inlet diameter DI. The internal passageway 116 preferably tapers narrowly from the inlet 112 to the outlet 114. More preferably, diametrically opposed surfaces defining the internal passageway 116 define an included angle of about twenty degrees (20°) about the sprinkler axis X-X. The discharge characteristics from the sprinkler body 110 and its outlet 114 preferably defines a nominal K-factor that is preferably less than K25 such as, for example, any one of K 22.4 GPM/(PSI)^{1/2} (hereinafter K22) (K320 metric), K 16.8 GPM/(PSI)^{1/2} (hereinafter K17) (K240 metric) or K 14.0 GPM/(PSI)^{1/2} (hereinafter K14) (K200 metric). More preferably, the sprinkler body 110 and its outlet 114 defines a nominal K-factor of 11.2 GPM/(PSI)^{1/2} or less and is even more preferably any one of K 8.0 GPM/(PSI)^{1/2} (hereinafter K8) (K115 metric) or a K 5.6 GPM/(PSI)^{1/2} (hereinafter K5.6) (K80 metric).

The preferred automatic sprinklers 100 of the system 10 are preferably configured such that fluid flow through the connected sprinkler 100 and its outlet 114 is controlled by a preferred seal assembly 400 having a translator 402 disposed within the passageway 116 proximate the outlet 114 to form a fluid tight seal therein. The translator 402 also forms a preferred pivoted relationship with respect to the frame 105 so that upon thermal actuation of a trigger 500, the translator 402 pivots out of the outlet 114 to permit the flow of atmospheric air into the sprinkler to expose the supply lines 20 and control system 26 to positive pressure and activate the water source 28. With reference to each of FIGS. 2 and 3, the preferred translator 402 preferably includes a first portion 402a embodied shell cap disposed in the outlet 114 and second elongate portion 402b, preferably embodied as a lever member affixed to the first portion 402a, that overlaps an edge of the outlet end of the body 110 to engage a notch formed in the frame body 110. In the preferred translator 402, the second portion 402b is preferably integrally formed with the first portion 402a. Alternatively, the second portion 402b can be affixed to the first portion 402a by other mechanical means provided the translator 402 can form the preferred pivoted relationship with respect to the frame 105 to open the sprinkler.

As shown in FIG. 3, the first shell cap portion 402a of the preferred translator 402 includes a bulbous body with an annular flange that together form a receptacle of the seal assembly 400. In the unactuated state of the sprinkler assembly 100, the bulbous body of the shell cap 402a is disposed within the outlet 114 and extends into the passageway 116 so that the bulbous body is exposed to the inlet 112. In the standby or non-activated state of the system, the shell cap portion 402a is subject to a vacuum force FVac directed toward the sprinkler inlet 112 that biases the translator 402 and its shell cap portion 402a into the outlet 114. The magnitude of the vacuum force FVac acting on the shell cap 402a is preferably defined by the negative pressure applied at the inlet 112 and the cross-sectional area of the passageway 116 normal to the sprinkler axis and more preferably directly related to the nominal K-factor of the preferred sprinkler frame 105.

In the unactuated state of the sprinkler, the outer surface of the annular flange of the shell cap 402a contacts the sealing surface of the body 110 circumscribing the outlet 114. Preferably disposed within the receptacle of the shell cap portion 402a is a seating disc 404 to seat the thermally responsive element or trigger 500 in the unactuated state of the sprinkler assembly 100. To retain the seating disc 404 within the receptacle, the annular flange includes one or more projection members 403, as seen in FIG. 2, that extend radially inward over the receptacle. The thermally responsive element 500 is preferably embodied as a thermally responsive frangible glass bulb but can be alternatively embodied as a thermally responsive mechanical or electrically actuated assembly, such as for example, a fusible soldered link and strut arrangement. A load screw 600 is threaded into the boss 122 of the frame 105 to provide a loading force against the trigger 500 and the seating disc 404 such that the shell cap 402a and its annular flange forms a fluid tight seal against the sealing surface circumscribing the outlet 114.

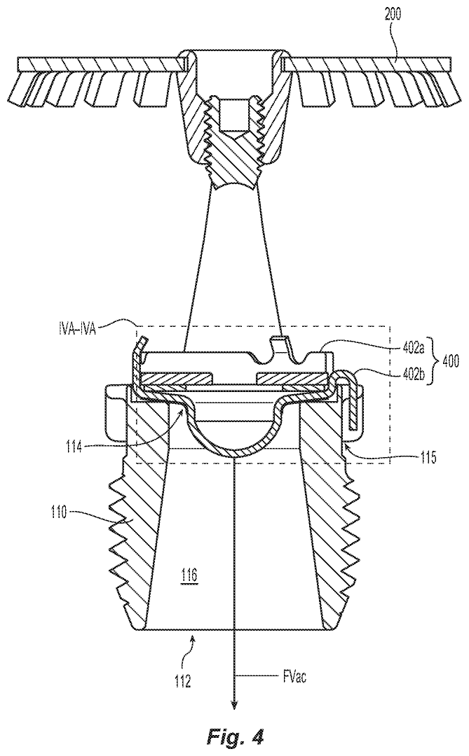

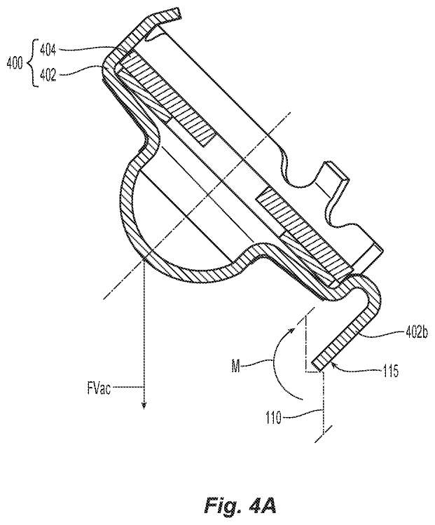

In the presence of a sufficient level of heat, the thermally responsive trigger 500 operates or actuates to release the compressive force acting on the sealing assembly 400 and the preferred translator 402. Shown in FIG. 4 is an illustrative schematic showing the translator 402 disposed in the outlet 114 just after actuation of the trigger 500 and still subject to the vacuum force FVac. Without the compressive force of the trigger 500, the lever member 402b of the translator 402 preferably forms a pivot point or fulcrum along a surface of the body 112 and more preferably within a notch 115 formed in the body 110. With reference to the schematic of FIG. 4A, the translator 402 thereby pivots about the pivot point and out of the outlet 114 and out of the axial fluid flow path between the outlet 114 and the deflector 200. The moment M about the fulcrum expels the sealing assembly 400 out of the outlet and the fluid flow path of the sprinkler. The pivot point shown is formed by surface contact between the end of the lever member 402b of the translator and the notch 115 formed in the peripheral surface of the sprinkler body 110. The pivot point or fulcrum can be alternatively located to provide the surface contact between the lever member 402b and the body 110 provides for the pivot to expel the assembly 400 out of the outlet 114 and fluid flow path. Thus, the translator 402 can form a pivoted engagement with any other surface or structure formed on or affixed to frame 105 provided it provides for the pivot to expel the assembly 400 out of the outlet 114 and fluid flow path.

Preferred embodiments of the translator 402 are configured with a moment generator arrangement to facilitate the pivoted action about the pivot point or fulcrum. For example, in one preferred operation of the sprinkler 100 embodiment shown, the operation or rupture of the thermal trigger 500 causes displacement of the seating disc 404 within the receptacle of the shell cap portion 402a. The seating disc 404 travels upward toward the deflector 200 and preferably impacts the projection tabs 403 of the annular flange of the shell cap portion 402a to impart a momentum to the translator 402 which pivots about the fulcrum formed with the notch 115. In an alternate pendent orientation of the sprinkler, the seating disc is displaced by the trigger operation and under the force of gravity travels downward toward an appropriate pendent-type deflector to impact the projection tabs of the annular flange of the shell cap portion 402a to pivot the translator 402 out of the sprinkler body 110 and the fluid flow path. Because the preferred translator 402, regardless of installation orientation, provides for a preferred pivoted arrangement to break the vacuum force FVac defined by the small K-Factor of the sprinkler (K11 or less) and translate the sealing assembly 400 out of the outlet 114 and axial fluid flow path, the preferred translator 402 eliminates that need for an expulsion member and/or thrust member to completely expel the sealing assembly 400 from the sprinkler frame 105. With the seal assembly 400 out of the outlet 114 and fluid flow path, atmospheric air or positive pressure can enter the sprinkler and the connected supply lines to activate the control system 26 and release of the pressurized firefighting fluid, which can be discharged from the outlet 114 to impact the deflector 200. Accordingly, automatic fire protection sprinklers having a nominal K-factor of K8 or K5.6 for vacuum dry fire protection systems and methods have been provided.

Although the previously described embodiment of the seal assembly 400 and translator 402 can provide a moment to expel the seal assembly from the outlet when combined with sprinkler frame bodies having a small K-factor (K11 or less), the seal assembly 400 can be combined with additional elements to add to the momentum of the seal assembly 400 and its complete translation out of the sprinkler flow path. Moreover, the following alternate arrangements of the seal assembly 400 can provide additional embodiments of the sprinkler assembly that are unique to dry vacuum systems and methods of fire protection. For example, in an alternate embodiment of the seal assembly, the seal assembly can include an annular spring disc disposed within the receptacle of the shell cap portion 402a to increase the momentum of the seating disc. With reference again to FIG. 3, the seal assembly 400 can include an annular spring disc 406 within the receptacle of the shell cap 402a that is disposed in the receptacle preferably between the seating disc and the shell cap to bias the seating disc and shell cap away from one another. The spring disc 406 preferably biases the seating disc 404 toward the projection member 403 of the annular flange and away from the bulbous body of the shell cap. In the unactuated sprinkler assembly, the load screw 600 is threaded into the boss 122 of the frame 105 to provide a loading force against the trigger 500 and the seating disc 404 to compress the internal spring disc 406 and place the exterior of the shell cap 402a in fluid tight sealed engagement against the sealing surface circumscribing the outlet 114. Upon thermal operation of the trigger 500, the relief of the compressive force allows the spring disc 406 to decompress and act against and propel the seating disc 404 to impact the projection members 403 of the shell cap 402a. Release of the spring disc 406 can impart additional momentum to the displaced seating disc 404 to increase the magnitude of the moment M of the preferred translator 402.

In another embodiment (not shown), an annular spring disc can be centered about the outlet 114 and located externally of the shell cap between the sealing surface of the sprinkler body 110 and the annular flange of the shell cap 402a to bias the seal assembly 400 out of the outlet 114 toward the deflector 200. The external annular spring disc can be used, in addition to or in place of the internal spring disc 406. In an unactuated state of such an assembly, the bulbous body of the shell cap 402a extends through the central aperture of the annular spring disc and the load screw 600 and trigger 500 compress the shell cap 402a against the external spring disc. The compressed annular spring disc forms a fluid tight sealed engagement against the sealing surface circumscribing the outlet 114. Upon thermal operation of the trigger 500, the relief of the compressive force allows the spring disc to decompress and act against the translator 402 with an axial force in the direction of the sprinkler axis. Because of the pivoted relationship of the translator 402, the small K-factor (K11 or less) of the frame 105 and the anticipated correspondingly small vacuum force FVac acting on the seal assembly, the spring disc can be of any size provided it has a sufficiently large central aperture to accommodate the bulbous portion of the shell cap 402a. Accordingly, one preferred embodiment of sprinkler arrangement includes a sprinkler frame having a nominal K-factor of either one of a K8 or K5.6.

In yet another embodiment not shown, the sprinkler assembly can include a wire spring member formed for urging the seal assembly transverse to the sprinkler axis X-X. The wire spring member can be used with one, both or neither of the internal or external spring discs previously described. For example, a spring member can be affixed to the frame arms 120 of the frame 105 to bias and push the seal assembly 400 transversely with respect to the sprinkler axis X-X. Alternatively, the spring member can be arranged to bias and pull the seal assembly transversely. In the preferred embodiment of the translator 402, the wire spring member can be arranged to act against the shell cap 402a, for example, at the annular flange. Alternatively, the spring member can directly against the lever member 402b of the translator 402.

In other preferred aspects of the sprinkler 100, the deflector 200 is affixed to the boss 122 to locate the deflector 200 at a first fixed distance H1 from the outlet 114 and at a second fixed distance H2 from the inlet 112. In a preferred embodiment, the deflector 200 is located at a preferred first fixed distance H1 from the outlet 114 that ranges from 1 inch to 1.25 inches and is more preferably about 1.125 inches. In the preferred embodiment, the deflector 200 is correspondingly located at a preferred second fixed distance H2 from the inlet 112 that ranges from 1.75 inches to 2 inches and more preferably ranges from 1.85 inches to 1.95 inches and is even more preferably about 1.9 inches.

The preferred deflector 200 is illustratively shown in FIGS. 1-4 bent or formed for installation in an upright orientation in which supplied firefighting fluid is discharged from the outlet 114 to impact the deflector 200 in an upward direction. The preferred upright deflector includes a circular central planar impact portion disposed perpendicular to the sprinkler axis X-X with a plurality of tines formed about the central planar portion. One or more of the tines are bent to angle out of plane from the central portion and extend in the direction of the sprinkler body 110. More preferably each of the tines of the deflection member define an obtuse included angle with the central portion of the deflection member and extend toward the body 110. In another alternate embodiment of the fluid deflection member 200, the member can be substantially domed shape so as to present a concave face to the sprinkler outlet 114.

In an alternative configuration of the affixed deflector 200 for a pendent-type installation orientation, a planar, preferably circular, member is disposed perpendicular to the sprinkler X-X. Slots are formed within the member, extending inward from the periphery of the circular member to a central portion of the member. The slots are spaced apart from one another by a plurality of peripheral tines that are in plane with the central portion of the planar member. At least one of the tines is preferably in plane with the central portion and more preferably each of the tines of the fluid deflector 200 is in plane with the central portion. In one alternate embodiment of the pendent sprinkler, one or more of the tines is out of plane with the central portion of the fluid deflection member. For example, one or more of the tines is skewed with respect to the central portion of the deflection member and extends away from the sprinkler body 110.

With reference to FIG. 2, the outer surface of the sprinkler body 110 is configured for connecting the sprinkler 10 to a fluid supply pipe. For example, a K5.6 sprinkler preferably includes an external pipe thread 111 configured as ½ inch-14 NPT. For the larger K8 sprinkler the external pipe thread can be configured as ½ inch-14 NPT or alternatively as ¾ inch-14 NPT pipe. To facilitate securement of the sprinkler body 110 to the fluid pipe, the sprinkler body 110 includes a wrench boss 118 with a hexagonal perimeter disposed about the outlet 114 and centered about the sprinkler axis X-X for engagement by an installation tool, such as for example, a sprinkler installation wrench.

A thermally responsive trigger 500 can be characterized by its thermal sensitivity which can be characterized by Response Time Index (“RTI”) which is measured in units of (ft·s)^{1/2} [(m·s)^{1/2}]. Under industry accepted standards, an RTI of 145-635 (ft·s)^{1/2} [80 (m·s)^{1/2} to 350 (m·s)^{1/2}] defines a “Standard Response” and an RTI equal to or less than 90 (ft·s)^{1/2} [50 (m·s)^{1/2}] defines a “Quick Response” The thermally responsive trigger 500 of preferred embodiments of the sprinklers 100 can be either one of “Standard Response” or “Quick Response”.

Preferred embodiments of the automatic fire protection sprinkler assemblies described herein provide preferred methods of vacuum dry sprinkler system protection. One preferred method includes obtaining an automatic fire protection sprinkler having a nominal K-factor of 11 GPM/(PSI)^{1/2} or less and providing the fire protection sprinkler for installation in a vacuum dry fire protection system. More preferably, the obtained sprinkler includes a sealing assembly that can be expelled out of the sprinkler outlet and the sprinkler flow path. Even more preferably, the method includes obtaining a sprinkler having a sealing assembly with a preferred translator for expelling the sprinkler without the need for an expulsion member or a thrust member. Obtaining a fire protection sprinkler assembly can include any one of manufacturing, acquiring, testing and/or purchasing a preferred fire protection sprinkler assembly as described herein. Providing the automatic sprinkler assembly for installation can preferably include giving, supplying, and/or selling the sprinkler for installation and use in a vacuum dry fire protection system.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A vacuum dry sprinkler system comprising:
a fire extinguishing fluid supply line;
a control system connected to the fire extinguishing fluid supply line, the control system being configured to maintain the fire extinguishing fluid supply line at below atmospheric or negative pressure during a non-activated condition and forward a fire extinguishing fluid to the fire extinguishing fluid supply line upon being exposed to pressure equal to or greater than atmospheric pressure in response to a fire in activated condition;
a plurality of vacuum dry sprinklers coupled to the fire extinguishing fluid supply line, each of the vacuum dry sprinklers including:
a frame including a frame having body having an inlet, an outlet and an internal passageway extending between the inlet and the outlet along a longitudinal sprinkler axis, the sprinkler body has a nominal K-factor of less than 25.2 GPM/(PSI)^{1/2};
a fluid deflecting member spaced from the outlet at a fixed axial distance from the outlet to define a fluid flow path in between;
a thermally sensitive trigger disposed between the fluid deflecting member and the outlet along the sprinkler axis; and
a seal assembly engaged with the trigger to form a fluid tight seal within the outlet, the seal assembly including a translator in a pivoted relationship with the frame upon rupture of the thermally responsive trigger to pivot the seal assembly out of the fluid flow path.

2. The system of claim 1, wherein the translator in each of the vacuum dry sprinklers is configured with a moment generator.

3. The system of claim 2, wherein the translator includes a shell cap engaged with the outlet, the shell cap defining a receptacle and a seating disc disposed within the receptacle to seat the thermally responsive trigger such that the operation of the thermally responsive trigger causes displacement of the seating disc to impact the shell cap and impart momentum to the translator.

4. The system of claim 3, wherein the shell cap includes a lever member defining the pivoted relationship as a pivot point along a surface of the sprinkler body of the frame, the shell cap including an annular flange to form the fluid tight seal about outlet and a bulbous body disposed within the outlet and extending into the internal passageway.

5. The system of claim 3, wherein the seal assembly includes an annular spring disc disposed in the receptacle between the seating disc and the shell cap to bias the seating disc and shell cap away from one another.

6. The system of claim 1, wherein the sprinkler body has a nominal K-factor being any one of: 11.2 GPM/(PSI)^{1/2}; 8.0 GPM/(PSI)^{1/2} or 5.6 GPM/(PSI)^{1/2}.

7. A method of vacuum dry sprinkler protection, the method comprising:
configuring a plurality of fire extinguishing fluid supply lines to be below atmospheric or negative pressure during a non-activated condition and forward a fire extinguishing fluid to the plurality of fire extinguishing fluid supply lines upon exposure to pressure equal to or greater than atmospheric pressure in an activated condition; and
coupling a plurality of vacuum dry sprinklers to the plurality of fire extinguishing fluid supply lines, each of the vacuum dry sprinklers including:
a frame including a frame having body having an inlet, an outlet and an internal passageway extending between the inlet and the outlet along a longitudinal sprinkler axis, the sprinkler body has a nominal K-factor of less than 25.2 GPM/(PSI)^{1/2};
a fluid deflecting member spaced from the outlet at a fixed axial distance from the outlet to define a fluid flow path in between;
a thermally sensitive trigger disposed between the fluid deflecting member and the outlet along the sprinkler axis; and a seal assembly engaged with the trigger to form a fluid tight seal within the outlet, the seal assembly including a translator in a pivoted relationship with the frame upon operation of the thermally responsive trigger to pivot the seal assembly out of the fluid flow path.

8. The method of claim 7, wherein the coupling includes providing the translator of the seal assembly with a moment generator that imparts a moment to the translator upon operation of the thermally responsive trigger.

9. The method of claim 8, wherein providing the translator with the moment generator includes providing a shell cap defining a receptacle and a seating disc disposed within the receptacle to seat the thermally responsive trigger such that the operation of the thermally responsive trigger causes displacement of the seating disc to impact the shell cap and impart momentum to the translator.

10. The method of claim 9, wherein providing the translator includes providing a lever member with the shell cap to define the pivoted relationship as a pivot point along a surface of the sprinkler body of the frame, and providing an annular flange to form the fluid tight seal about outlet with a bulbous body of the shell cap disposed within the outlet and extending into the internal passageway.

11. The method of claim 10, wherein providing the translator includes providing an annular spring disc disposed in the receptacle between the seating disc and the shell cap to bias the seating disc and shell cap away from one another.

12. The method of claim 7, wherein coupling the plurality of vacuum dry sprinklers includes providing that the sprinkler body of each has a nominal K-factor being any one of: 11.2 GPM/(PSI)^{1/2}; 8.0 GPM/(PSI)^{1/2} or 5.6 GPM/(PSI)^{1/2}.

13. A method of vacuum dry fire protection comprising,
obtaining an automatic fire protection sprinkler having a nominal K-factor of 11.2 GPM/(PSI)^{1/2} or less; and
providing the fire protection sprinkler suitable for installation in a vacuum dry fire protection system having a supervisory vacuum pressure.

14. The method of claim 13, wherein providing the fire protection sprinkler includes providing that the sprinkler includes:
a frame including a frame having body having an inlet, an outlet and an internal passageway extending between the inlet and the outlet along a longitudinal sprinkler axis;
a fluid deflecting member spaced from the outlet at a fixed axial distance from the outlet to define a fluid flow path in between;
a thermally sensitive trigger disposed between the fluid deflecting member and the outlet along the sprinkler axis; and
a seal assembly engaged with the trigger to form a fluid tight seal within the outlet, the seal assembly including a translator in a pivoted relationship with the frame upon operation of the thermally responsive trigger to pivot the seal assembly out of the fluid flow path.

15. The method of claim 14, wherein providing the fire protection sprinkler includes providing the translator of the seal assembly with a moment generator that imparts a moment to the translator upon operation of the thermally responsive trigger.

16. The method of claim 15, wherein providing the translator with the moment generator includes providing a shell cap defining a receptacle and a seating disc disposed within the receptacle to seat the thermally responsive trigger such that the operation of the thermally responsive trigger causes displacement of the seating disc to impact the shell cap and impart momentum to the translator.

17. The method of claim 16, wherein providing the translator includes providing a lever member with the shell cap to define the pivoted relationship as a pivot point along a surface of the sprinkler body of the frame, and providing an annular flange to form the fluid tight seal about outlet with a bulbous body of the shell cap disposed within the outlet and extending into the internal passageway.

18. The method of claim 17, wherein providing the translator includes providing an annular spring disc disposed in the receptacle between the seating disc and the shell cap to bias the seating disc and shell cap away from one another.

19. The method of claim 13, wherein providing the fire protection sprinkler suitable for installation in a vacuum dry fire protection system includes providing the supervisory vacuum pressure is no more than −3 psi.

20. The method of claim 13, wherein obtaining an automatic fire protection sprinkler includes obtaining a sprinkler with the nominal K-factor being any one of: 11.2 GPM/(PSI)^{1/2}; 8.0 GPM/(PSI)^{1/2} or 5.6 GPM/(PSI)^{1/2}.
